(19) United States
(12) Patent Application Publication
(10) Pub. No.: US 2014/0229834 A1
(43) Pub. Date: Aug. 14, 2014

(54) METHOD OF VIDEO INTERACTION USING POSTER VIEW

(71) Applicant: AMIT KUMAR JAIN, NEW DELHI (IN)

(72) Inventor: AMIT KUMAR JAIN, NEW DELHI (IN)

(21) Appl. No.: 14/176,071

(22) Filed: Feb. 8, 2014

(30) Foreign Application Priority Data
Feb. 12, 2013 (IN) 413MUM/2013

(51) Int. Cl. G06F 3/0484

(52) U.S. Cl. CPC G06F 3/0484
USPC 715/720

(57) ABSTRACT

In the present invention, the means of control and navigation 100 of an electronic device 108 are used for viewing an embodiment of a video, wherein said embodiment is a cached or stored “poster-view” 1 that is a representation and a version of a source video. Said poster-view 1 has integration with the content of said source video. This method implements the use of means of control and navigation 100 of said electronic device 108 to extend the contents of said poster-view 1 from an initial form 4 to an extended form 3 and from said extended form 3, retract the contents of the poster-view to said initial form 4, within the spatial bounds of the poster-view.

### BACKGROUND

1. Technical Field

The disclosed method is generally related to video interaction, and more particularly to video interaction using electronic devices that play video, and to change the content mode of the video by using means of control & navigation available on said electronic device.

2. Description of the Related Art

Over the past decade video interaction has improved by leaps and bounds and in the present day, it is omnipresent in almost all platforms of human communication. Video interaction is used in entertainment as in movies and video games, broadcasting, blogging, communications using video calling, video chatting, video conferencing, video messaging, and broadcasting, advertisements, information exchange, security and surveillance and so on. With the ever increasing number of uses and applications of video interaction, the number of hardware platforms on which video playback are supported have also increased and each of these various hardware platforms have different ways in which a user can interact with the operating system that runs these platforms.

A lot of these hardware platforms are portable electronic devices that have touchscreens. Today we have a lot of applications that deal with plurality of videos where multiple videos that can be chosen by a user to view are displayed on a web page using thumbnails which are just a small graphical representation of those videos and are not actually the real videos themselves. To select a video, a user has to click or tap (depending on the hardware platform being used) on the thumbnail representing the video. Today's state of video technology opens a video when it is selected via its respective thumbnail from the web or device's storage where the source video is stored and plays the video in dimensions defined by the application being used. Hence, the function of a thumbnail is that, it is just a pictorial representation of the video and it is not the video itself.

If a user wants to see a plurality of such videos in finer details, he or she is forced to go to full-screen that causes inconvenience to the user as the current and associated information is compromised, as each video is viewed in full screen individually. Therefore, what is needed is a method of viewing a plurality of videos in their finer content details, playing as the representation they are presented as to the user initially, which would enable a user to view the finer content details of the plurality of videos without going to full screen for each individually.

### SUMMARY OF THE INVENTION

The present invention relates to a method of video interaction using electronic devices and in particular to electronic devices with touch screen wherein the means of control and navigation of an electronic device are used for viewing an embodiment of a video wherein said embodiment is a cached or stored “poster-view” that is a representation and a version of a source video wherein said poster-view has integration with the content of said source video. It enables a user to view the finer content details of the video without leaving the current view of the screen or changing the spatial bounds of the region within which the video is being played. Hence, a user can view the finer details of the content of a plurality of videos simultaneously in the same view since the spatial bounds of each poster-view is not changed. The average size of a poster view may be such that multiple poster-views can be viewed in a single view on the screen of the device. Hence, this makes it ideal for applications like (but not limited to) video news feeds in social media, blogs and advertisements. The main advantage of the poster-view over the playing of the source video is that here, the real source video need not be accessed and opened every time the user wishes to view it. A poster-view plays the contents of the source video within itself as the contents of the source video are automatically integrated, pre-indexed and stored within the poster view itself that enables it to play itself as the source video.

This method implements using means of control and navigation of said electronic device to extend the contents of said embodiment by changing the content mode of said embodiment wherein the content mode is changed from an aspect-to-fit mode to an aspect-to-fill mode in accordance to the content properties of the source video, resulting in an extended form of said embodiment from an initial form of said embodiment. The method also implements using means of control and navigation to contract the contents of said embodiment by changing the content mode of said embodiment is changed from said aspect-to-fill mode to said aspect-to-fit mode in accordance to the content properties of the source video, resulting in said initial form of said embodiment from said extended form.

Extension of the content and up-scaling of said embodiment is performed simultaneously so that it enhances the video-quality and retains its original compositional screen size while it plays in said extended form for better video quality and viewing pleasure.

Upon selection of a poster-view 1 using the means of control and navigation 100 of an electronic device 108 for example, by tapping on the poster-view 1 displayed on a touch screen 107, the contents of the source video are played within the spatial bounds 102 of the poster-view's 1 dimension on the display screen 101 in the same manner as the real source video would have been played.

In one aspect of the present invention, the invention can be implemented in video applications which are capable of displaying overlay view of options 103, apart from providing the basic operations 104 of playing, stopping, pausing, forwarding and rewinding a video. The overlay view of options 103 may provide features such as change of orientation, share, add to favorites etc. Upon loading of such an application that is installed on the device, a view 200 opens up on the display 101 wherein a region 106 where at least one poster-view 1 is displayed for the user to select and play using the means of control and navigation 100 of the device. If the electronic device 108 has a touchscreen or touchpad as the means of control and navigation, a single tap gesture or a double tap gesture may be performed by at least one finger of the user to operate on the means of control and navigation 100 present in the electronic device.

A single tap gesture may be performed by the user on a region 102 within the spatial bounds of at least one poster-view(s) 1 other than the region where the play icon(s) 105 of the at least one poster-view (s) 1 is displayed on the screen 101, and this shows an overlay view of options 103. A single tap gesture may be performed by the user on a region where the play icon(s) 105 of the at least one poster-view(s) 1 is displayed to play the poster-view(s) 1 the user wishes to see. A double tap gesture may be performed by the user, on a region 102 where a poster-view 1 he/she wants to select is displayed within the region 106 where the at least one poster-view 1 is displayed, to select a poster-view 1 and extend the contents of the poster-view 1 without changing the play mode (that is, the video will keep playing if it was playing or stay in stop mode if it was in stop mode). In the extended form 3 of a poster-view 1, a single tap gesture may be performed by the user on region 102 to pause the playing of the poster-view 1 if it is being played to open an overlay view of options 103. A double tap gesture may be performed by the user on the region 102 where the poster-view 1 is displayed to retract the contents of said extended form 3 to said initial form 4 without changing the play mode.

The present invention can also be implemented in video applications which are capable of playing at least one poster-view 1 without any support for overlay view of options 103. A single tap gesture may be performed by the user on the region where a play icon(s) 105 is displayed to play the at least one poster-view (resulting in poster-view in play mode 2). A double tap gesture may be performed by the user, on a region 102 where a poster-view 1 he/she wants to select is displayed within the region 106 where the at least one poster-view 1 is displayed, to select a poster-view 1 and extend the contents of the poster-view 1 without changing the play mode. A single tap gesture may be performed by the user on a region 102 where said poster-view 1 is displayed to pause it if it is being played. In the extended form 3, a double tap gesture may be performed by the user on the region 102 where the poster-view 1 is displayed retracts the contents of the poster-view 1 to its initial form 4 without changing the play mode.

The present invention can also be implemented in video applications that plays at least one poster-view 1 upon loading. A double tap gesture may be performed by the user, on a region 102 where a poster-view 1 he/she wants to select is displayed within the region 106 where the at least one poster-view 1 is displayed, to select a poster-view 1 and extend the contents of the poster-viewer 1. In this extended form 3, a double tap gesture performed by the user on the region 102 where the poster-view 1 is displayed to retract the contents of the poster-view 1 from the extended form 3 to its initial form 4.

### BRIEF DESCRIPTION OF THE DRAWINGS

FIG. 1 illustrates a plurality of poster-views displayed on the screen of an electronic device.

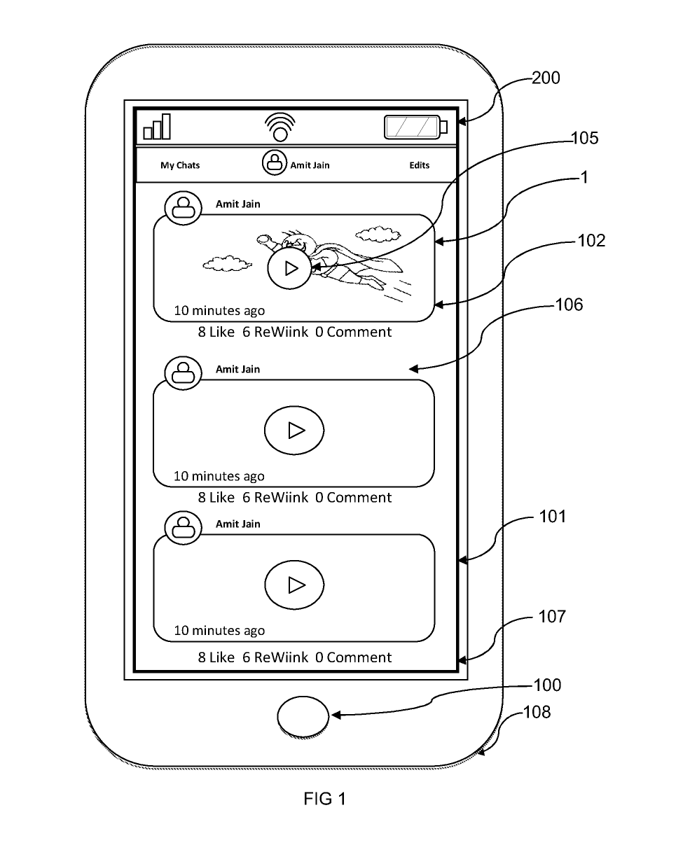

FIG. 2 illustrates a poster-view playing in initial form displayed on the screen of an electronic device.

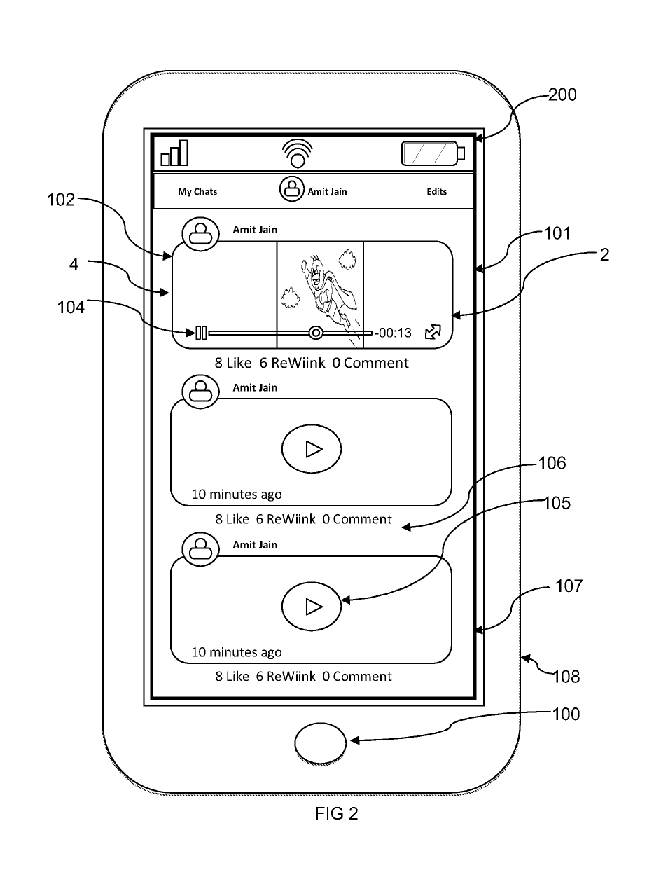

FIG. 3 illustrates a poster-view in extended form with an overlay view of options displayed on the screen of an electronic device.

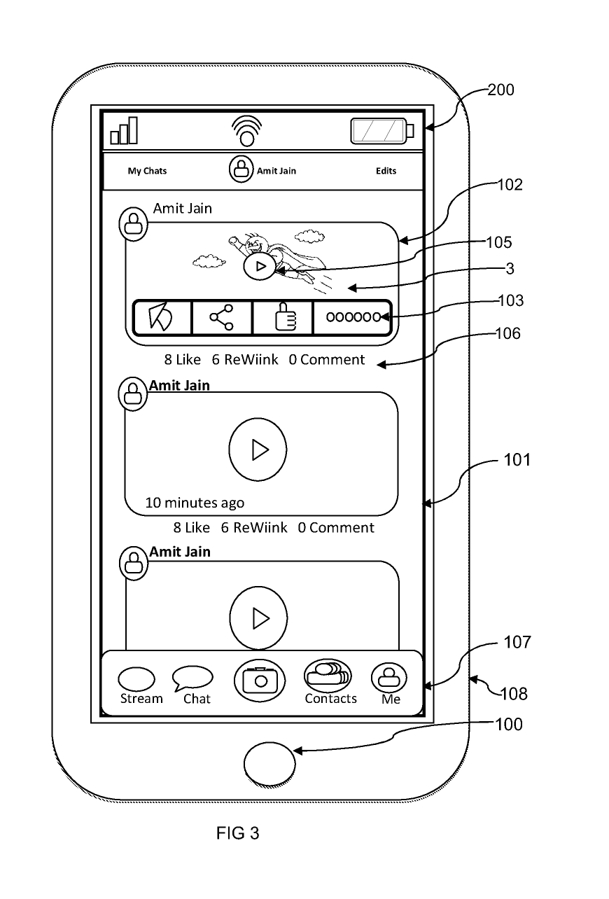

FIG. 4 illustrates a poster-view playing in extended form displayed on the screen of an electronic device.

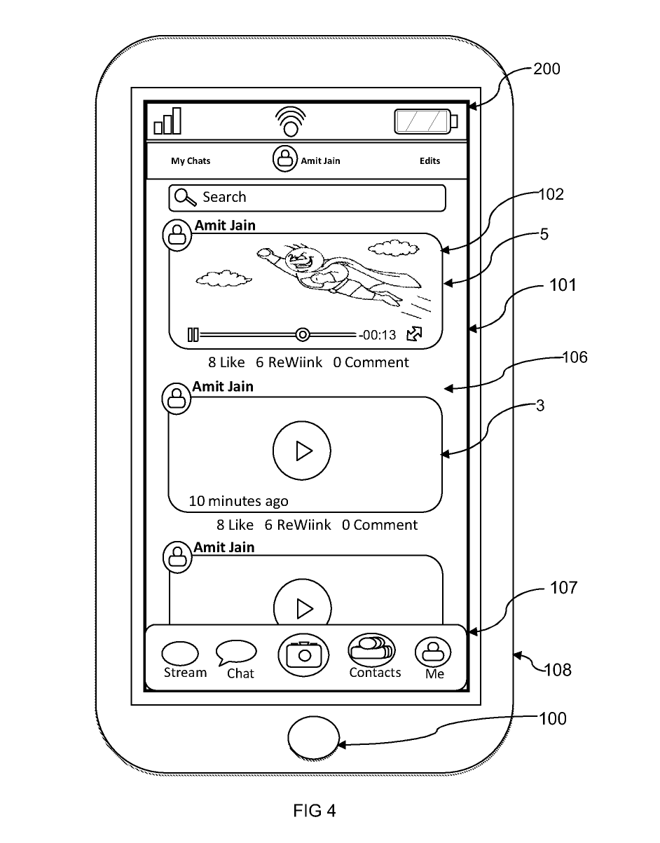

FIG. 5 illustrates a poster-view in extended form stop mode displayed on the screen of an electronic device.

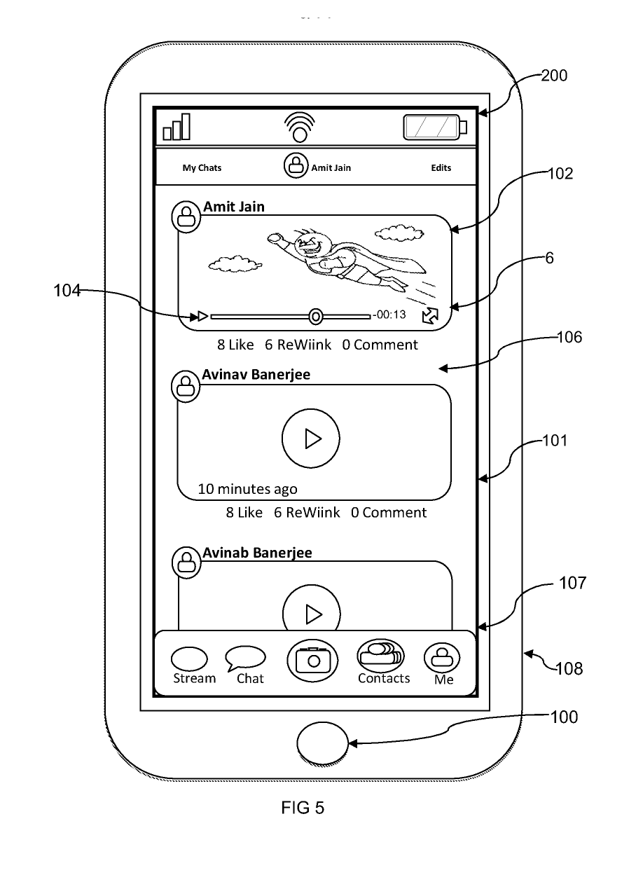

FIG. 6 illustrates a poster-view in initial form in stop mode displayed on the screen of an electronic device.

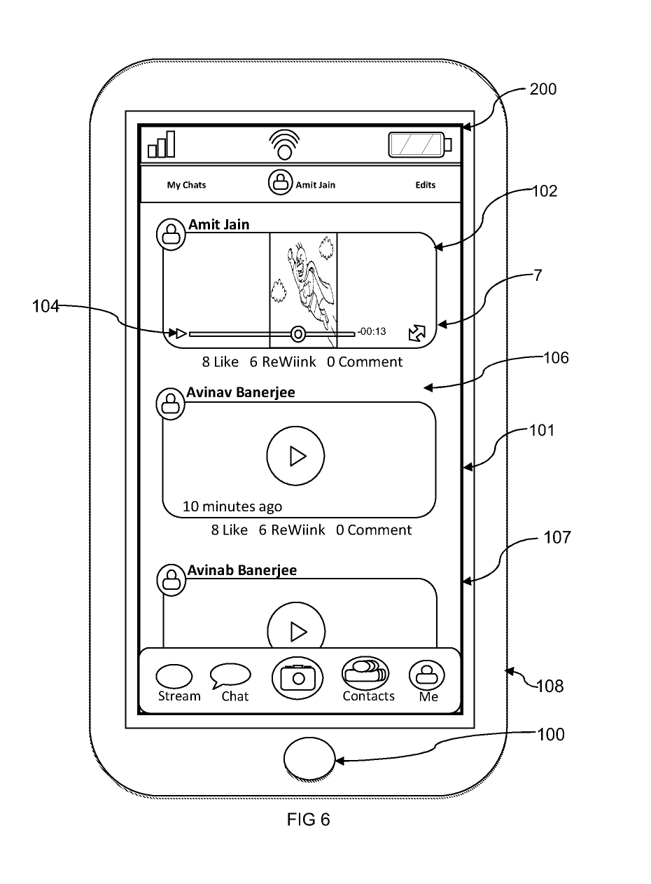

FIG. 7 illustrates a poster-view in initial form with an overlay view of options displayed on the screen of an electronic device.

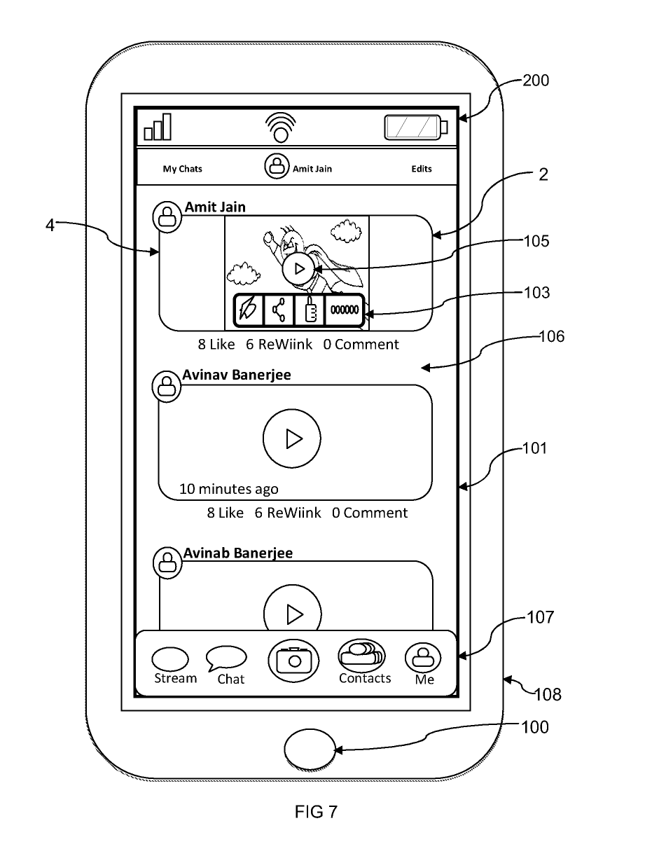

FIG. 8 illustrates a flow diagram that explains the working of the invention implemented with a video application that plays videos and provides an overlay view of options.

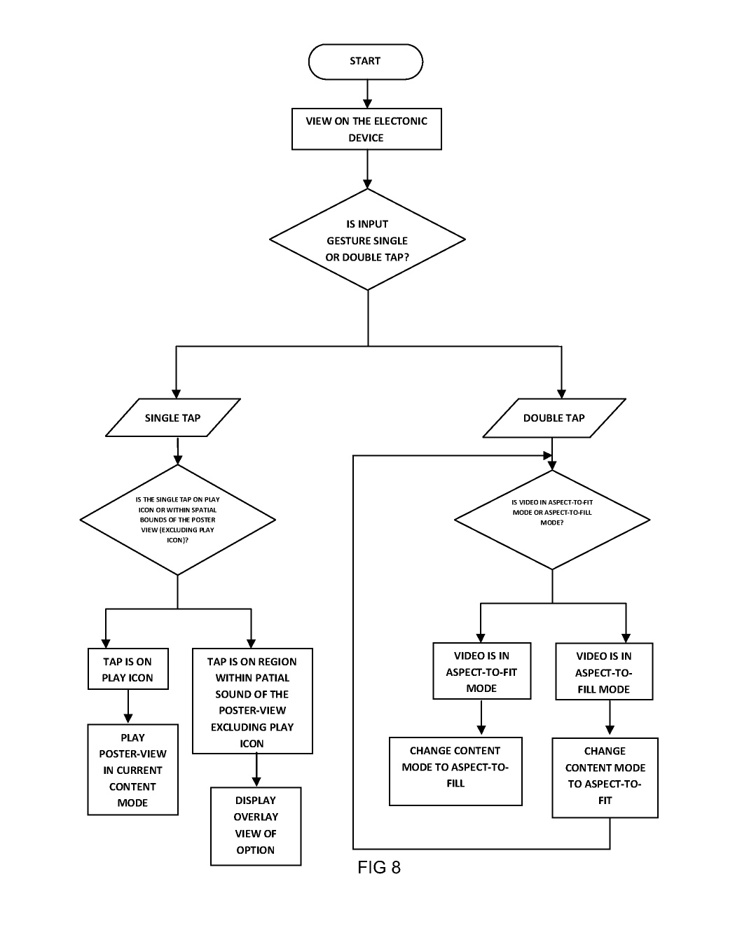

FIG. 9 illustrates a flow diagram that explains the working of the invention implemented with a video application that plays videos and does not provide an overlay view of options.

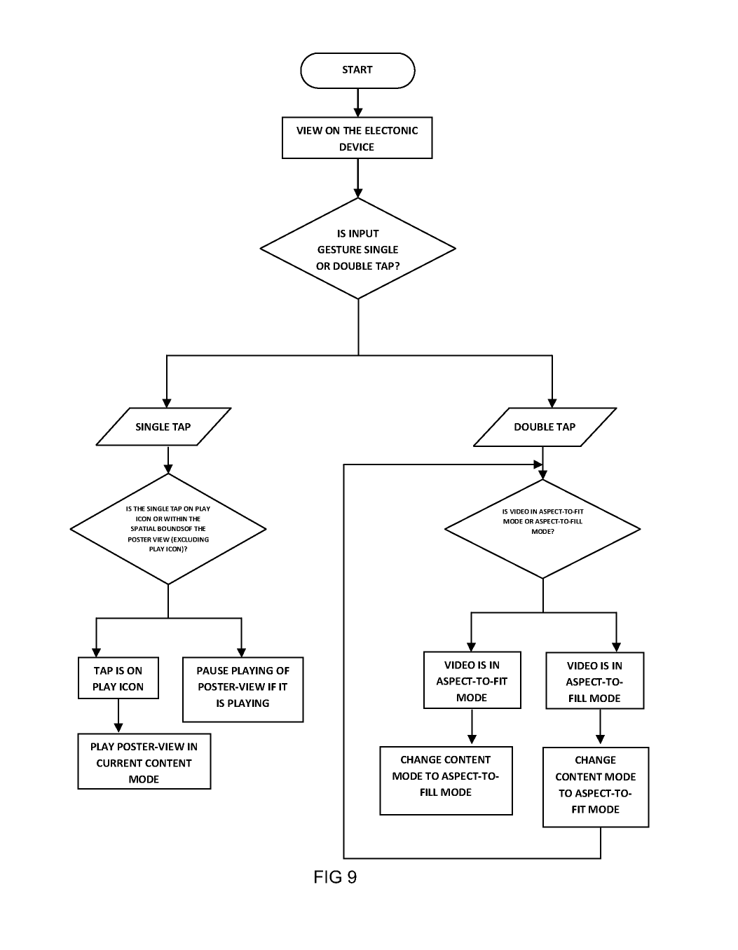

FIG. 10 illustrates a flow diagram that explains the working of the invention implemented with a video application that plays videos upon loading.

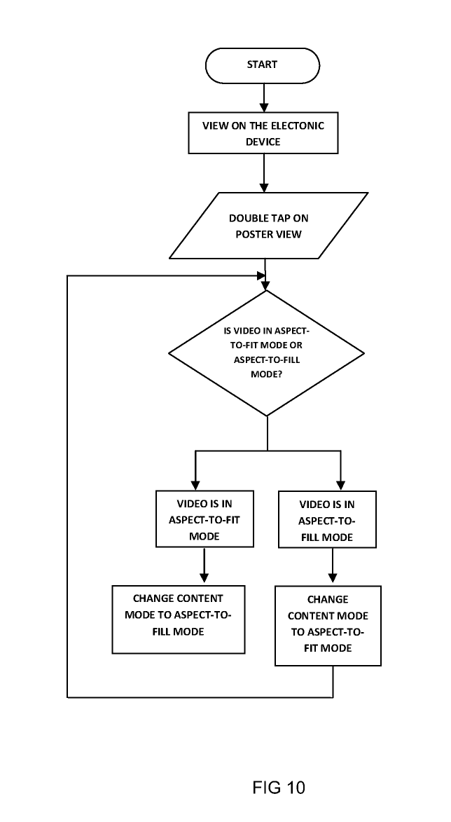

FIG. 11 illustrates a poster-view playing in initial form wherein the source video is of low resolution.

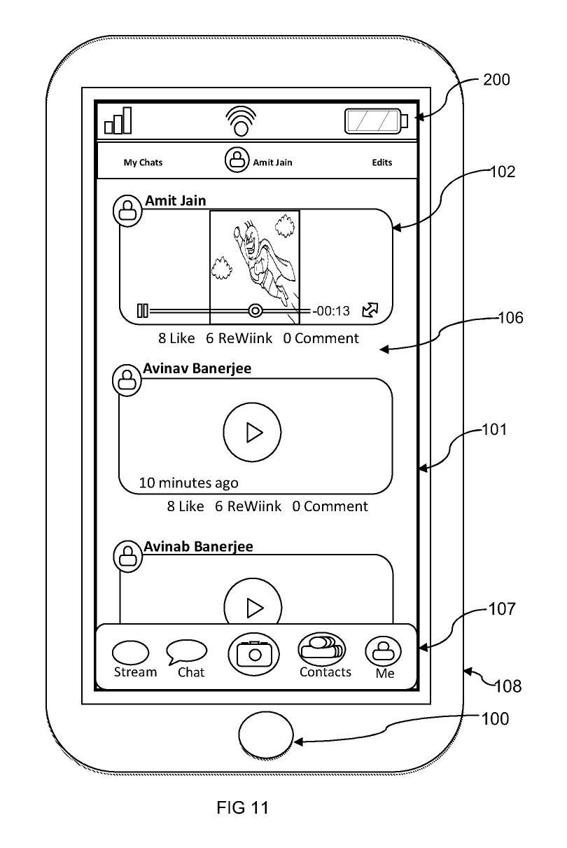

FIG. 12 illustrates the video of FIG. 11 playing in extended form wherein the video quality is compromised in extended form as the source video is of low resolution.

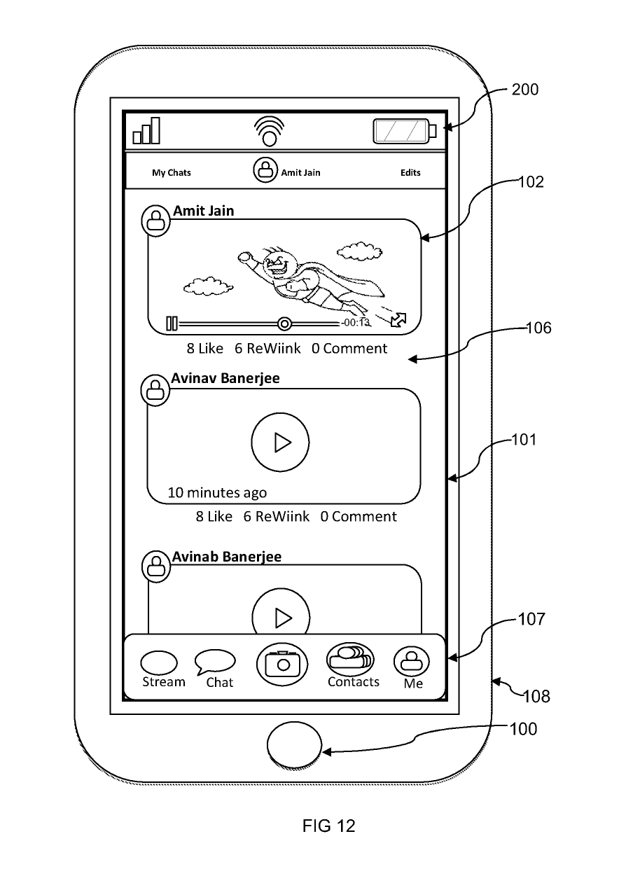

FIG. 13 illustrates the video of FIG. 11 playing in extended form wherein quality of the video is not compromised as up-scaling is performed.

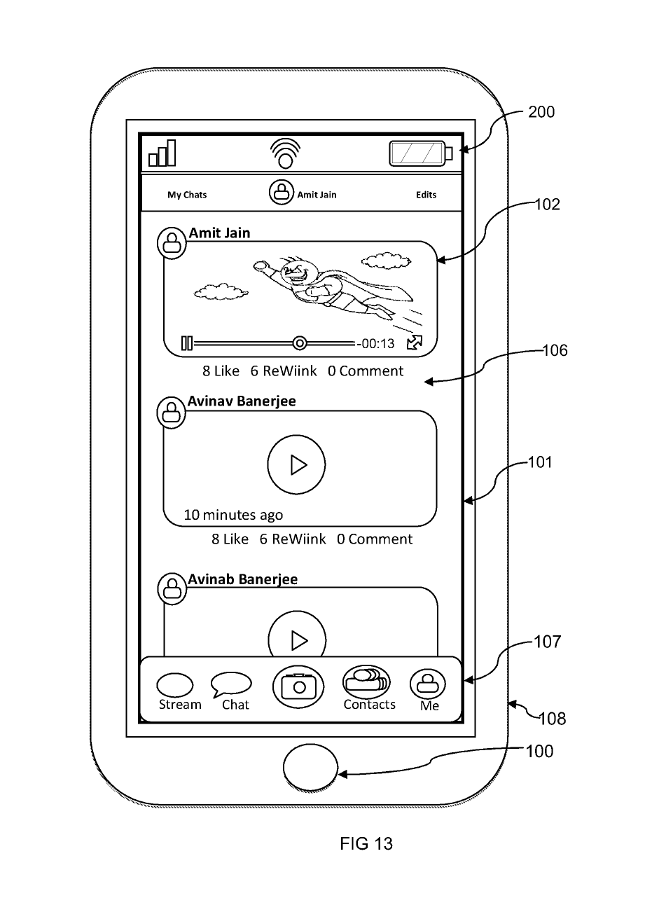

FIG. 14 illustrates a flow diagram that explains when up-scaling is done.

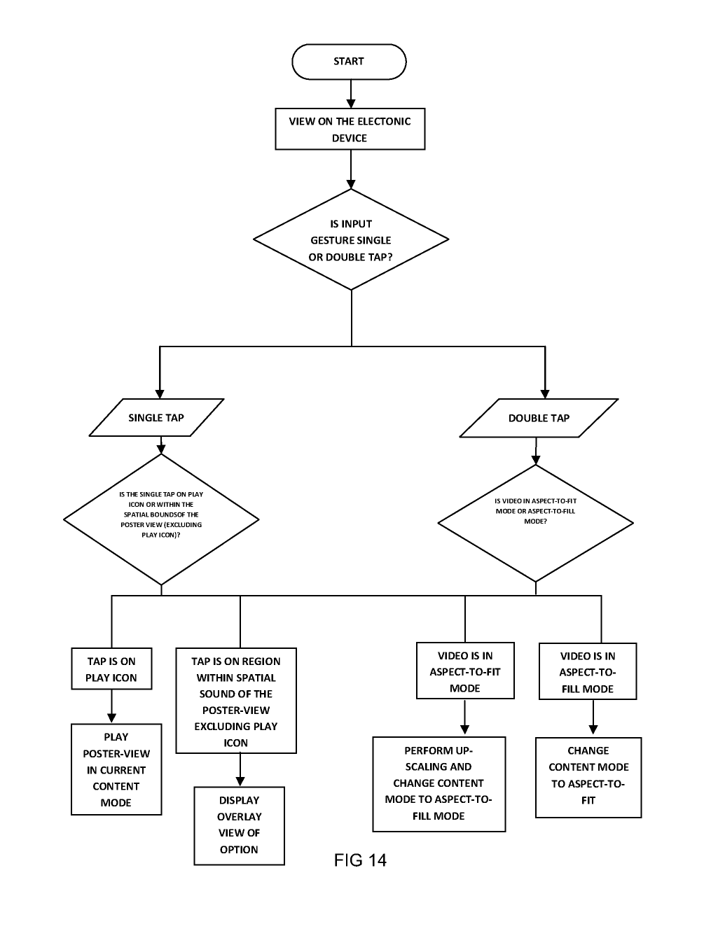

### DETAILED DESCRIPTION

The following detailed description contains specific details that are set forth to provide a comprehensive understanding of the present invention. In one implementation, one or more of the techniques described herein can be implemented as features within any type of program or service that provides video interaction and playback.

The video applications and services through which the present invention can be implemented with are various, such as, video conferencing applications, instant video messaging applications, blogging applications, digital video camera applications, web browsing applications, digital video player applications and many others. The various applications that can implement the present invention run on electronic devices that may use at least one physical user interface device that provide the means of control and navigation within the operating system and applications that run on the devices include (but not limited to) touch-pads such as those described in (but not limited to)

(1) U.S. patent application Ser. No. 10/722,948 (“Touch pad for handheld device”, filed Nov. 25, 2003); (2) U.S. patent application No. Ser. 10/188,182 (“Touch pad for handheld device”, filed Mar. 21, 2006) (3) U.S. patent application Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touchscreens such as those described in (but not limited to) (1) U.S. patent application Ser. No. 11/381,313, “Multipoint Touch Surface Controller,” filed on May 2, 2006;

(2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005;

(7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheel such as those described in U.S. patent application Ser. No. 11/549,619 “Method, device, and graphical user interface for dialing with a click wheel” filed on Oct. 13, 2006, keyboards such as those mentioned in (but not limited to) U.S. patent application Ser. No. 07/711,760 (“Ergonomic keyboard input device”, filed on Jun. 6, 1991), mouse such as those described in (but not limited to)

(1) application Ser. No. 09/167,314 (“Computer mouse with enhance control button (s)”, filed on Oct. 6, 1998); (2) application Ser. No. 08/288,945 (“Roller mouse for implementing scrolling in windows applications “, filed on Aug. 10, 1994) and gesture recognition means such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

The various hardware platforms on which the applications that implement the present invention run may use one or more processors with different instruction-sets, architectures, clock-speeds, etc. and memory that may include high speed random access memory and may include non-volatile memory such as one or more magnetic disk storage devices, flash memory devices and other kinds of solid state memory devices.

Display means used by these hardware platforms may use LCD (liquid crystal display) technology, LED (light Emitting Diode) technology, CRT (Cathode ray tube) technology, or LPD (light emitting polymer) technology or any other display technologies. Various realizations of graphics display circuitry that implement a Graphics Processing Unit (GPU) may be used to achieve video interface between user and these devices.

Connectivity of these devices with networks such as the internet, an intranet and/or wireless network such as cellular telephone network, a wired or wireless local area network (LAN) and/or metropolitan area network (MAN) and/or WAN (wide area network) and other wireless communication is achieved by use of a plurality of communication standards, protocols and technologies like Global System for mobile communication (GSM), Enhanced Data GSM Environment (EDGE), wideband code division of multiple access (W-CDMA), code division of multiple access (CDMA), time division multiple access (TDMA), Bluetooth, Wireless Fidelity (Wi-Fi) and/or any other suitable communication protocol, including communication protocols not yet developed as of the filing date of this document.

Audio interface between a user and these devices is achieved by use of various realizations of audio circuitry. The present invention maybe implemented on applications that run on a single or variety of operating system platforms including but not limited to OS X, WINDOWS, UNIX, IOS, ANDROID, SYMBIAN, LINUX, or embedded operating systems such as Vx Works.

The present invention maybe implemented to work with various video formats including but not limited to MPEG-4, AVI, FLV, WMV, DIVX, MKV and VOB. The present invention may also be implemented to work with various web browsers including but not limited to Internet Explorer, Mozilla Firefox, Safari and Opera that access and handle various types of web pages constructed with various markup languages such as (but not limited to) HTML, HTML-5, XHTML, XML, etc. and the associated CSS (cascading style sheet) files and JavaScript files.

The present invention uses a novel method of video interaction that implements a poster-view 1 which is a representation and version of a source video. The poster-view 1 is not simply a thumbnail (thumbnails are reduced-size versions of pictures, used to help in recognizing and organizing them, serving the same role for images as a normal text index does for words) that represents a video on the screen, which upon selection opens and plays the source video.

The poster-view 1 is a cached or stored version of the source video which may be stored on the memory of a device or on a cloud (server) in the web. The size of the poster view 1 can be customized according to the utility of a video application. Usually, the size of a poster-view 1 of a video is around the same size as that of an average thumbnail. Upon selection of a poster-view 1 using the means of control and navigation 100 of an electronic device 108, for example, by tapping on the poster-view 1 displayed on a touch screen 107, the contents of the source video are played within the spatial bounds 102 of the poster-view's 1 dimension on the display screen 101 in the same manner as the real source video would have been played.

A poster-view 1 plays the contents of the source video within itself as the contents of the source video are automatically integrated, pre-indexed and stored within the poster view 1 itself that enables it to play itself as the source video. Once a poster-view is selected to play (poster-view in play mode 2), means of control and navigation 100 of an electronic device 108 are used to extend the contents of the poster-view 1 wherein the content mode of said poster-view 1 is changed from an aspect-to-fit mode to an aspect-to-fill mode in accordance to the content properties of the source video, resulting in an extended form 3 of said poster view from its initial form 4.

Once in the extension mode 3, means of control and navigation 100 are used to contract the contents of said embodiment wherein the content mode of said poster-view 1 is changed from said aspect-to-fill mode to said aspect-to-fit mode in accordance to the content properties of the source video, resulting in said initial form 4 of said poster-view 1 from said extended form 3. Extension of the content and up-scaling of the poster view 1 is triggered simultaneously so that it enhances the video-quality and retains its original compositional screen size while it plays in extended form (poster-view playing in extended form 3) for better video quality and viewing pleasure.

Up-scaling or up-converting is the process of converting a video signal from a low resolution (e.g. standard definition) to one of higher resolution (e.g. high definition television). Video up-scaling is achieved up adding extra pixels to a video with respect to its contents so that a low resolution video signal is converted to one of higher resolution. Video up scaling is achieved by using a video scaler device found embedded in devices like computer monitors, scan conversion devices, televisions, video editing and broadcasting equipment, other audio/visual devices and video game consoles (like Xbox 360 and play station 3).

The scaler studies a group of pixels (or digital data pertaining to), these are called ‘taps’, surrounding the one it wants to create and uses these as a reference source to ‘guess’ what the new one should look like. Up scaling of the video may be done such as those described in (but not limited to) (1) U.S. patent application Ser. No. 11/987,814 (“Method and apparatus for video up scaling”, filed on Dec. 5, 2007) (2) U.S. patent application Ser. No. 08/561,907 (“Method and apparatus for up scaling video images when pixel data used for up scaling a source video image are unavailable”, filed on Nov. 22, 1995).

The dimensions of the initial form in play mode 2 and extended form in play mode 5 depend on operating conditions like the utility of the application, the hardware and software conditions and the user's preferences. Aspect-to-fit mode makes sure the whole video is visible proportionally. Aspect-to-Fill will make sure there is no space left in the video viewing area on the display while sizing the contents of the video proportionally.

Original compositional screen size is the specifications with regard to the dimensions in which the original video was shot or created. The quality of the poster-view 1 with respect to the original video contents is maintained by performing up-scaling wherein up-scaling is a process that mathematically matches the pixel count of the output of a standard source video signal to the physical pixel count available on a display screen 101.

In one aspect of the present invention, the invention can be implemented in video applications which are capable of displaying overlay view of options 103, apart from providing the basic operations 104 of playing, stopping, pausing, forwarding and rewinding a video. The overlay view of options 103 may provide features such as change of orientation, share, add to favorites etc.

Upon loading of such an application that is installed on the device, a view 200 opens up on the display 101 wherein a region 106 where at least one poster-view 1 is displayed for the user to select and play using the means of control and navigation 100 of the device. If the electronic device has a touchscreen or touchpad as the means of control and navigation 100, a single tap gesture or a double tap gesture may be performed by at least one finger of the user to operate on the means of control and navigation 100 present in the electronic device.

A single tap gesture may be performed by the user on a region 102 within the spatial bounds of at least one poster-view(s) 1 other than the region where the play icon(s) 105 of the at least one poster-view (s) 1 is displayed on the screen 101, and this shows an overlay view of options 103. A single tap gesture may be performed by the user on a region where the play icon(s) 105 of the at least one poster-view(s) 1 is displayed to play the poster-view(s) 1 the user wishes to see.

A double tap gesture may be performed by the user on a region 102 where a poster-view 1 he/she wants to select is displayed within the region 106 where the at least 1 one poster-view 1 is displayed to select a poster-view 1 and extend the contents of the poster-view 1 without changing the play mode. In the extended form 3 of a poster-view 1, a single tap gesture may be performed by the user on region 102 to pause the playing of the poster-view 1 if it is being played to open an overlay view of options 103.

A double tap gesture may be performed by the user on the region 102 where the poster-view 1 is displayed to retract the contents of said extended form 3 to said initial form 4 without changing the play mode. In another aspect, the present invention can be implemented in video applications which are capable of playing at least one poster-view 1 without any support for overlay view of options 103. A single tap gesture may be performed by the user on the region where a play icon(s) 105 is displayed to play the at least one poster-view (resulting in poster-view in play mode 2).

A double tap gesture may be performed by the user on a region 102 where a poster-view 1 he/she wants to select is displayed within the region 106 where the at least one poster-view 1 is displayed to select a poster-view 1 and extend the contents of the poster-view 1 without changing the play mode. A single tap gesture may be performed by the user on a region 102 where said poster-view 1 is displayed to pause it if it is being played. In the extended form 3, a double tap gesture performed by the user on the region 102 where the poster-view 1 is displayed retracts the contents of the poster-view 1 to its initial form 4 without changing the play mode (that is, the video will keep playing if it was playing or stay in stop mode if it was in stop mode).

In another aspect, the present invention can be implemented in video applications that plays at least one poster-view 1 upon loading. A double tap gesture may be performed by the user on a region 102 where a poster-view 1 he/she wants to select is displayed within the region 106 where the at least one poster-view 1 is displayed to select a poster-view 1 and extend the contents of the poster-viewer 1. In this extended form 3, a double tap gesture performed by the user on the region 102 where the poster-view 1 is displayed retracts the contents of the poster-view 1 from the extended form 3 to its initial form 4.

What is claimed is:

1. A method of video interaction, the method comprising:
using a means of control and navigation of an electronic device for enabling the viewing of an embodiment of a video wherein said embodiment is a cached or stored poster-view that is a representation and a version of a source video wherein said poster-view has integration with the content of said source video;
using the means of control and navigation of said electronic device to enable a user to extend the contents of said embodiment by changing the content mode of said embodiment from an aspect-to-fit mode to an aspect-to-fill mode in accordance to the content properties of the source video, resulting in an extended form of said embodiment from an initial form of said embodiment; and
using the means of control and navigation of said electronic device to enable the user retract the contents of said embodiment by changing the content mode of said embodiment from said aspect-to-fill mode to said aspect-to-fit mode in accordance to the content properties of the source video, resulting in said initial form of said embodiment from said extended form.

2. The method according to claim 1, wherein extension and up-scaling of said embodiment is performed simultaneously so that it enhances the video-quality of said embodiment in said extended form and said embodiment will retain its original compositional screen size while it plays in said extended form.

3. The method according to claim 1, wherein use of a single tap gesture and use of a double tap gesture is made wherein the single tap gesture or the double tap gesture are performed by at least one finger of the user to operate on the means of control and navigation present in said electronic device.

4. The method according to claim 1, wherein an installed video application capable of displaying an overlay view of options and playing said at least one embodiment(s), when selected by the user using the graphical user interface of said electronic device's operating system, opens a view on the display screen of said electronic device to show said at least one embodiment(s) the user wishes to see.

5. The method according to claim 4, wherein a single tap gesture performed by the user opens said overlay view of options, wherein said single tap gesture is performed on a region within the spatial bounds of said at least one embodiment(s) other than the region where a play icon(s) of said at least one said embodiment(s) is displayed.

6. The method according to claim 4, wherein a single tap gesture performed by the user on a region where the play icon(s) of said at least one embodiment(s) is displayed plays said at least one embodiment(s).

7. The method according to claim 4, wherein a double tap gesture performed by the user on a region within the spatial bounds of said at least one embodiment(s) changes the form of said at least one embodiment(s) to said extended form from said initial form without changing the play mode of said at least one embodiment(s).

8. The method according to claim 7, wherein a single tap gesture performed by the user on the region within the spatial bounds of said at least one embodiment(s) pauses the playing of said at least one embodiment(s) if it is being played, and said overlay view of options is opened.

9. The method according to claim 7, wherein a double tap gesture performed by the user on the region within the spatial bounds of said at least one embodiment(s) changes the form of said at least one embodiment(s) from said extended form to said initial form without changing the play mode.

10. The method according to claim 1, wherein an installed video application capable of playing said at least one said embodiment(s) without any support for overlay view of options, when selected by the user using the graphical user interface of said electronic device's operating system, opens a view on the display screen of said electronic device to show said at least one embodiment(s) the user wishes to see.

11. The method according to claim 10, wherein a single tap gesture performed by the user on a region where a play icon(s) of said at least one embodiment(s) is displayed plays said at least one embodiment(s).

12. The method according to claim 10, wherein a double tap gesture performed by the user on a region within the spatial bounds of the at least one said embodiment(s) changes the form of said at least one embodiment(s) to said extended form from said initial form without changing the play mode.

13. The method according to claim 12, wherein a single tap gesture performed by the user within the spatial bounds of said at least one said embodiment(s) pauses the playing of said at least one embodiment(s) if it (they) is (are) being played.

14. The method according to claim 12, wherein a double tap gesture performed by the user on the region within the spatial bounds of said at least one embodiment(s) changes the form of said at least one embodiment(s) from said extended form to said initial form without changing the play mode.

15. The method according to claim 1, wherein an installed video application that plays said at least one said embodiment(s) upon loading, when selected by the user using the graphical user interface of said electronic device's operating system, opens a view on the display screen of said electronic device that shows said at least one said embodiment(s) the user wishes to see.

16. The method according to claim 15, wherein a double tap gesture performed by the user on the region within the spatial bounds of said at least one embodiment(s) changes the form of said at least one embodiment(s) to said extended form from said initial form.

17. The method according to claim 15, wherein a double tap gesture performed by the user on the region within the spatial bounds of the at least one said embodiment(s) changes the form of said at least one embodiment(s) from said extended form to said initial form.
